(19) United States
(12) Patent Application Publication
(10) Pub. No.: US 2024/0010448 A1
(43) Pub. Date: Jan. 11, 2024

(54) GLASS SLIDE CONVEYANCE DEVICE AND GLASS SLIDE IMAGE CAPTURING SYSTEM

(71) Applicant: SONY GROUP CORPORATION, TOKYO (JP)

(72) Inventor: SHIGERU TAMURA, TOKYO (JP)

(21) Appl. No.: 18/255,041

(22) PCT Filed: Oct. 28, 2021
(86) PCT No.: PCT/JP2021/039770

§ 371 Date: May 30, 2023

(30) Foreign Application Priority Data
Dec. 8, 2020 (JP) 2020-203566

(51) Int. Cl. B65G 49/06; G02B 21/36; G02B 21/06; G02B 21/34

(52) U.S. Cl. CPC B65G 49/06; G02B 21/362; G02B 21/06; G02B 21/34

(57) ABSTRACT

Provided is a glass slide conveyance device (300) including: an arm member (316) provided to be movable in a first direction on a plane and having, at a distal end, a first contact member that comes in contact with a first end surface of the glass slide; a support plate (320) that includes a second contact member that comes in contact with a second end surface of the glass slide, the second end surface located opposite to the first end surface in the first direction, the supported plate being configured to support the glass slide from below; a driver that drives the arm member to be movable in the first direction; and a biasing member (312) provided between the driver and the arm member. When the arm member moves to a position where the first contact member and the second contact member simultaneously come in contact with the glass slide, the biasing member biases the arm member in the first direction.

### FIELD

The present disclosure relates to a glass slide conveyance device and a glass slide image capturing system.

### BACKGROUND

In recent years, there has been developed a microscope system (glass slide image capturing system) capable of automatically performing digital image capturing of a glass slide on which a biological specimen (for example, a cell tissue or the like) is mounted. Specifically, the microscope system prepares a large number of glass slides in slide storage, and by using a slide handler (glass slide conveyance device), repeatedly takes out the glass slide one by one from the slide storage and conveys the glass slide to a stage where image capture is performed. This operation makes it possible to automatically perform microscopic image capturing of a large amount of glass slides without human manipulation.

### CITATION LIST

### Patent Literature

Patent Literature 1: WO 2019/036647 A
Patent Literature 2: WO 2014/027450 A
Patent Literature 3: JP 2012-177804 A

### SUMMARY

### Technical Problem

However, with a microscope system (glass slide image capturing system) according to the conventional technique, there have been cases where the slide handler (glass slide conveyance device) cannot appropriately grip the glass slide at the time of conveying the glass slide, resulting in a failure such as a falling or breakage of the glass slide. In addition, with the microscope system according to the conventional technique, there have been cases where the glass slide is broken when being gripped by the slide handler, glass powder generated by the breakage causes a conveyance error of the slide handler, or an abrasion of component of the slide handler results in a conveyance error of the slide handler.

In view of these, the present disclosure proposes a glass slide conveyance device and a glass slide image capturing system capable of appropriately conveying a glass slide.

### Solution to Problem

According to the present disclosure, there is provided a glass slide conveyance device that conveys a glass slide on which a biological specimen is mounted. The glass slide conveyance device including: an arm member provided to be movable in a first direction on a plane and having, at a distal end, a first contact member that comes in contact with a first end surface of the glass slide; a support plate that includes a second contact member that comes in contact with a second end surface of the glass slide, the second end surface located opposite to the first end surface in the first direction, the supported plate being configured to support the glass slide from below; a driver that drives the arm member to be movable in the first direction; and a biasing member provided between the driver and the arm member. In the glass slide conveyance device, when the arm member moves to a position where the first contact member and the second contact member simultaneously come in contact with the glass slide, the biasing member biases the arm member in the first direction.

Furthermore, according to the present disclosure, there is provided a glass slide image capturing system including: a glass slide storage section that stores a plurality of glass slides on each of which a biological specimen is mounted; an image capturing section that captures an image of each of the glass slides; and a slide conveyer that conveys each of the glass slides between the glass slide storage portion and the image capturing section. In the glass slide image capturing system, the glass slide conveyer includes: an arm member provided to be movable in a first direction on a plane and having, at a distal end, a first contact member that comes in contact with a first end surface of the glass slide; a support plate that includes a second contact member that comes in contact with a second end surface of the glass slide, the second end surface located opposite to the first end surface in the first direction, the supported plate being configured to support the glass slide from below; a driver that drives the arm member to be movable in the first direction; and a biasing member provided between the driver and the arm member, when the arm member moves to a position where the first contact member and the second contact member simultaneously come in contact with the glass slide, the biasing member biases the arm member in the first direction.

### BRIEF DESCRIPTION OF DRAWINGS

FIG. 1 is a diagram illustrating an appearance of a glass slide 800 used in an image capturing system 10 according to an embodiment of the present disclosure.

FIG. 2 is a diagram illustrating a configuration example of the image capturing system 10 according to the embodiment of the present disclosure.

FIG. 3 is a diagram illustrating an appearance of slide storage 100 according to the embodiment of the present disclosure.

FIG. 4 is a diagram illustrating an appearance of an image capturing block 200 according to the embodiment of the present disclosure.

FIG. 5 is a perspective view (part 1) illustrating a slide handler 300 according to a first embodiment of the present disclosure.

FIG. 6 is a perspective view (part 2) illustrating the slide handler 300 according to the first embodiment of the present disclosure.

FIG. 7 is a cross-sectional view illustrating the slide handler 300 according to the first embodiment of the present disclosure.

FIG. 8 is a diagram illustrating an operation of the slide handler 300 according to the first embodiment of the present disclosure.

FIG. 9 is a diagram illustrating a detection mechanism according to a second embodiment of the present disclosure.

FIG. 10 is a diagram illustrating a detector 340 according to the second embodiment of the present disclosure.

FIG. 11 is a diagram illustrating a detection mechanism according to a modification of the second embodiment of the present disclosure.

FIG. 12 is a diagram illustrating a guide mechanism according to a third embodiment of the present disclosure.

FIG. 13 is an explanatory diagram (part 1) illustrating an operation of a slide handler 300 according to a fourth embodiment of the present disclosure.

FIG. 14 is an explanatory diagram (part 2) illustrating an operation of the slide handler 300 according to the fourth embodiment of the present disclosure.

FIG. 15 is an explanatory diagram (part 3) illustrating an operation of the slide handler 300 according to the fourth embodiment of the present disclosure.

FIG. 16 is an explanatory diagram (part 4) illustrating an operation of the slide handler 300 according to the fourth embodiment of the present disclosure.

FIG. 17 is an explanatory diagram (part 5) illustrating an operation of a slide handler 300 according to a fourth embodiment of the present disclosure.

FIG. 18 is an explanatory diagram (part 6) illustrating an operation of the slide handler 300 according to the fourth embodiment of the present disclosure.

FIG. 19 is a diagram illustrating an example of a schematic configuration of a diagnosis support system 5500 to which the technology according to the present disclosure is applied.

### DESCRIPTION OF EMBODIMENTS

Preferred embodiments of the present disclosure will be described in detail hereinbelow with reference to the accompanying drawings. Note that redundant descriptions will be omitted from the present specification and the drawings by assigning the same reference signs to components having substantially the same functional configuration. Moreover, in the present specification and the drawings, a plurality of components having substantially the same or similar functional configuration will be distinguished by attaching different alphabets after the same reference numerals. However, when it is not particularly necessary to distinguish between the plurality of components having substantially the same or similar functional configuration, only the same reference numeral is given.

In addition, in the following description, a tissue section or a cell that is a part of a tissue (for example, an organ or epithelial tissue) acquired from a living body (for example, a human body, an animal, a plant, or the like) is referred to as a biological specimen (or a sample). Note that the biological specimen described below may be subjected to various types of staining as necessary. In other words, in the embodiment of the present disclosure described below, unless otherwise specified, the biological specimen may be or need not be subjected to various types of staining. Furthermore, for example, the staining not only includes general staining typified by hematoxylin-eosin (HE) staining, Giemsa staining, or Papanicolaou staining, but also includes periodic acid-Schiff (PAS) staining or the like used when focusing on a specific tissue, and fluorescent staining such as fluorescence in-situ hybridization (FISH) or an enzyme antibody method.

Note that the description will be provided in the following order.

1. Background of creation of embodiments of present disclosure

1.1 Example of glass slide 800

1.2 Configuration example of image capturing system 10

1.3 Background of creation

1.4 Overview of embodiments of present disclosure

2. First Embodiment

2.1 Detailed configuration

2.2 Operation

2.3 Contact members 318 and 322

3. Second Embodiment

3.1 Detailed configuration

3.2 Modifications

4. Third Embodiment

5. Fourth Embodiment

6. Summary

7. Examples of application to products

8. Supplementary notes

### 1. Background of Creation of Embodiments of Present Disclosure

First, before describing the embodiments of the present disclosure, the background of the creation of the embodiments of the present disclosure by the present inventors will be described.

<1.1 Example of Glass Slide 800>

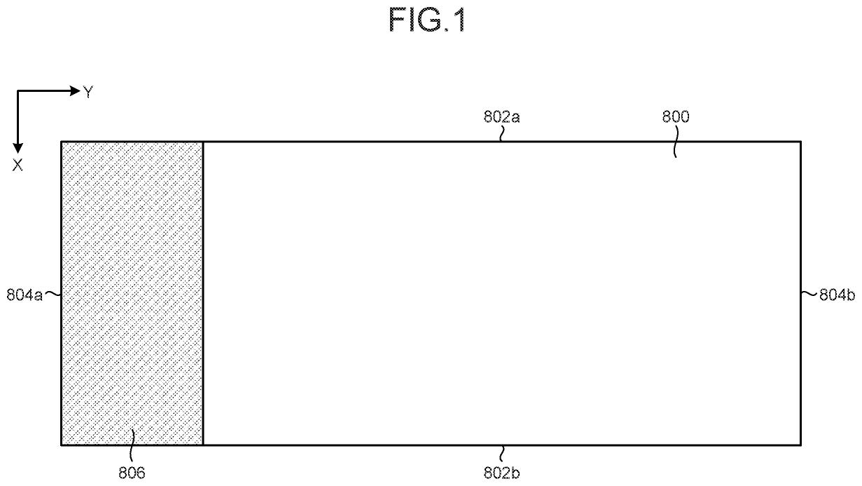

First, a glass slide 800 used in an image capturing system 10 according to the embodiment of the present disclosure will be described with reference to FIG. 1. FIG. 1 is a diagram illustrating an appearance of the glass slide 800 used in the image capturing system 10 according to the embodiment of the present disclosure.

As illustrated in FIG. 1, the glass slide 800 used in the image capturing system 10 according to the embodiment of the present disclosure is a glass piece cut into a rectangle, and a biological specimen as an observation target is to be mounted in a central portion of a front surface of the glass piece. Specifically, the glass slide 800 has a width in the X-axis direction (lateral direction) satisfying a predetermined dimensional standard, being a width 25 mm to 27 mm, or example. In addition, the glass slide 800 has a width in the Y-axis direction (longitudinal direction) satisfying a predetermined dimensional standard, being a width 75 mm to 77 mm, for example. Furthermore, the glass slide 800 has end surfaces 804a and 804b extending in the X-axis direction and facing each other, and has end surfaces 802a and 802b extending in the Y-axis direction in FIG. 1 and facing each other. Incidentally, the glass slide 800 is basically unprocessed after being cut out from the glass plate in many cases. Therefore, these end surfaces (edges) 802a, 802b, 804a, and 804b are not smooth in many cases, possibly including burrs (protrusions and the like generated at the time of processing), for example.

Furthermore, at the end of the front surface of the glass slide 800, there may be provided a portion such as a region referred to as a frost portion where a biological specimen is not mounted, or a label portion 806 in which identification information of the glass slide 800 is described.

<1.2 Configuration Example of Image Capturing System 10>

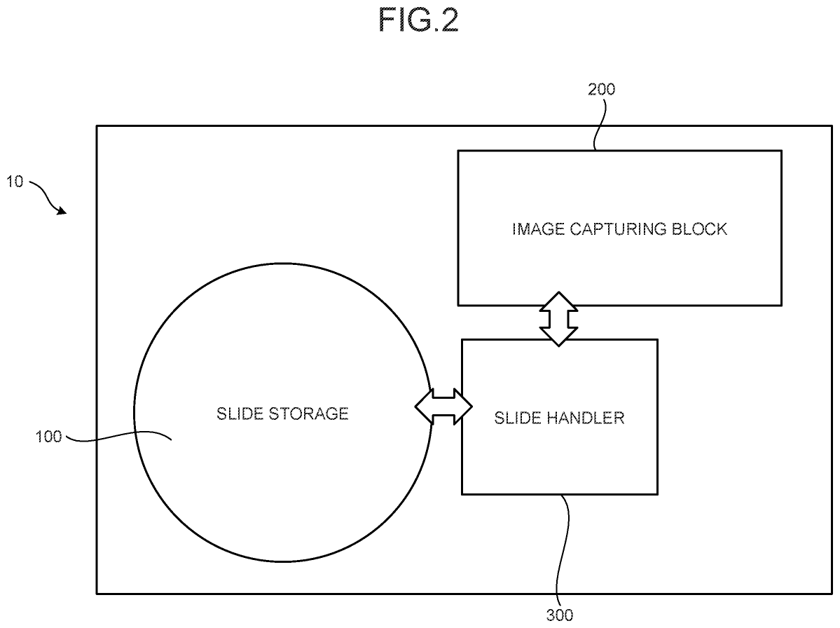

Next, a functional configuration example of the image capturing system 10 according to the embodiment of the present disclosure will be described with reference to FIG. 2. FIG. 2 is a diagram illustrating a configuration example of the image capturing system 10 according to the embodiment of the present disclosure. The image capturing system 10 according to the present embodiment is a microscope system capable of performing digital image capturing of the glass slide 800 on which the biological specimen (such as a cell tissue, for example) is mounted.

Specifically, as illustrated in FIG. 2, the image capturing system 10 according to the present embodiment includes slide storage (a glass slide storage section) 100 that stores a plurality of glass slides 800 on each of which a biological specimen is mounted. Furthermore, the image capturing system 10 according to the present embodiment mainly includes: an image capturing block (image capturing section) 200 that captures a digital image of each glass slide 800; and a slide handler (slide conveyer) 300 that carries and conveys each glass slide 800 back and forth between the slide storage 100 and the image capturing block 200. In addition, the image capturing system 10 further includes a control unit (not illustrated).

Specifically, the slide handler 300 can convey the glass slide 800 under automatic control. Therefore, the image capturing system 10 according to the present embodiment can automatically and sequentially perform digital image capturing in a short time on hundreds of glass slides 800 stored in the slide storage 100. For example, by using the image capturing system 10 according to the present embodiment, even at night when the laboratory technicians are absent, it is possible to automatically perform image capturing of the glass slide 800 on which a large number of biological specimens are mounted, making it possible to shorten the examination diagnosis time and make up for the shortage of the laboratory technicians. Hereinafter, details of individual devices included in the image capturing system 10 according to the present embodiment will be described.

(Slide Storage 100)

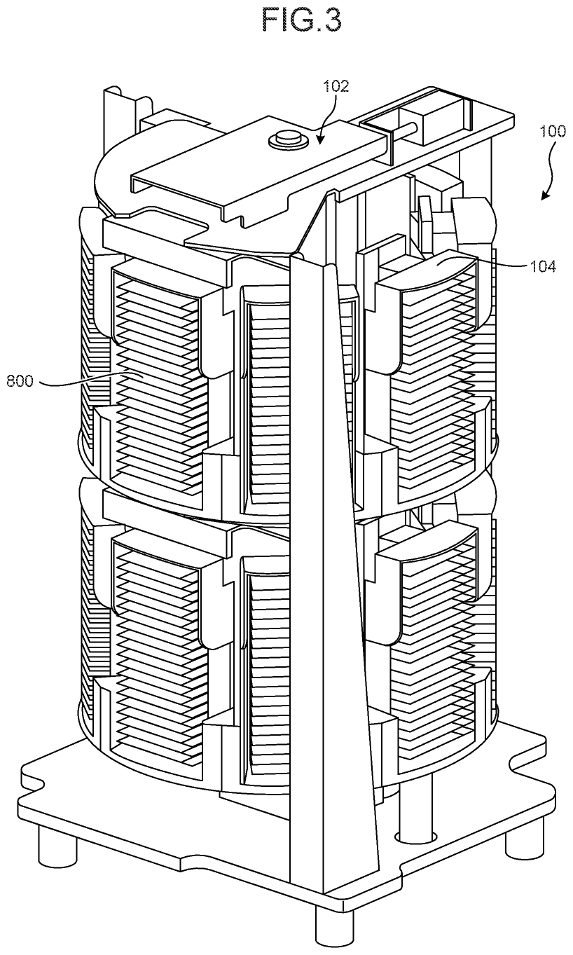

First, an outline of the slide storage 100 according to the present embodiment will be described with reference to FIG. 3. FIG. 3 is a diagram illustrating an appearance of the slide storage 100 according to the present embodiment.

Specifically, as illustrated in FIG. 3, the slide storage 100 according to the present embodiment stores a plurality of cassettes 104, each of which individually storing a plurality of glass slides 800. For example, the cassette 104 can be detachably attached to a space on a side surface of a housing 102 of the slide storage 100 having a shape of a cylinder. Furthermore, the housing 102 can rotate about a central axis of the cylinder as a rotation axis, and its rotation is controlled by a control unit (not illustrated) to be described below. In addition, the cassette 104 stores each of the glass slides 800 so as to be parallel to the horizontal plane, specifically, stores the glass slide 800 with one of the end surfaces 802a and 802b of the glass slide 800 in the Y-axis direction (longitudinal direction) facing outward. More specifically, the cassette 104 has a plurality of a pair of plates (not illustrated) provided in parallel with the horizontal plane, and stores the glass slides 800 so as to be inserted between the pair of plates. In the present embodiment, the glass slide 800 inserted between the pair of plates is extracted one by one by the slide handler 300 and conveyed to the image capturing block 200.

(Image Capturing Block 200)

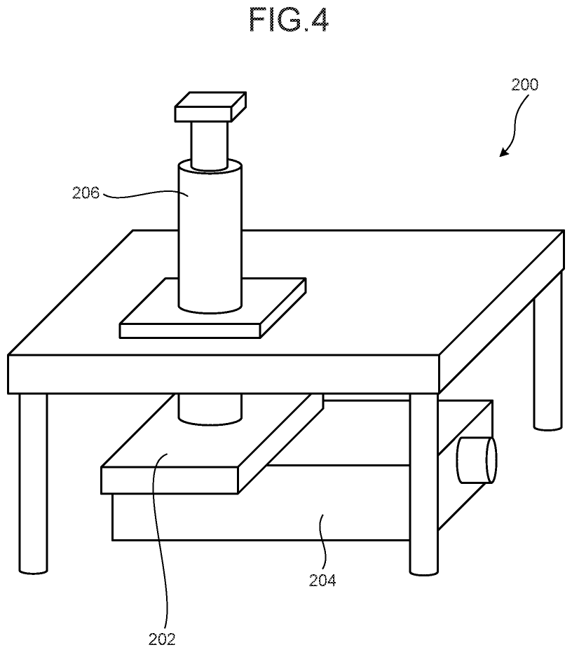

Next, an outline of the image capturing block 200 according to the present embodiment will be described with reference to FIG. 4. FIG. 4 is a diagram illustrating an appearance of the image capturing block 200 according to the present embodiment.

Specifically, the image capturing block 200 according to the present embodiment includes a stage 202 on which the glass slide 800 is placed. The stage 202 can move, in a state where the glass slide 800 is placed, in a direction (X-axis direction or Y-axis direction) parallel to a horizontal plane and can further move in a direction (Z-axis direction) perpendicular to the horizontal plane. In the present embodiment, the stage 202 is moved by a stage driving mechanism 204 controlled by a control unit (not illustrated) to be described below. There may be provided, in the stage driving mechanism 204, a light source (not illustrated) that emits light from below the glass slide 800 to be placed on the stage 202. The light emitted from the light source is not particularly limited, and may be visible light of red, blue, or green color, or white light, or infrared light, with no particular limitation.

In addition, the image capturing block 200 includes a microscope 206 that captures an image of a biological specimen mounted on the glass slide 800 placed on the stage 202. For example, the microscope 206 mainly includes an image sensor (not illustrated) and a lens system (not illustrated). Specifically, the lens system includes a plurality of lenses including an objective lens and an imaging lens, and can magnify the biological specimen on the glass slide 800 illuminated by the light source (not illustrated) of the stage 202 to a predetermined magnification or can form an image of the biological specimen on the image sensor. Furthermore, the image sensor can be implemented by an imaging element such as a charge coupled device (CCD) or a complementary metal oxide semiconductor (CMOS), for example. In addition, an image in an image capturing range having a predetermined horizontal width and a predetermined vertical width on the glass slide 800 is formed on the image sensor in accordance with the size of the image sensor and the magnification of the lens. Specifically, in the present embodiment, the image sensor may be a line sensor that repeats imaging of a thin rectangular region with its own movement or movement of the stage 202 to image an image capturing range having a predetermined horizontal width and a predetermined vertical width. Alternatively, in the present embodiment, the image sensor may be an area sensor that images an image capturing range (for example, an image capturing region of several mm×several mm) having a predetermined horizontal width and a predetermined vertical width without repeating its own movement or the movement of the stage 202. Furthermore, in the present embodiment, the image data acquired by the image sensor can be, for example, transmitted to the control unit (not illustrated) to be described below, then, processed or output to another device (such as a display device, for example).

In the present embodiment, the glass slide 800 conveyed from the slide storage 100 is placed on the stage 202 by the slide handler 300, thereby capturing an image of the biological specimen mounted on the glass slide 800.

(Slide Handler 300)

Since details of the slide handler 300 according to the present embodiment will be described below, description of the slide handler 300 is omitted here.

(Control Unit)

Furthermore, in the present embodiment, the image capturing system 10 includes the control unit (not illustrated) as described above. The control unit can control individual devices of the image capturing system 10, perform predetermined image processing or the like on image data obtained by image capturing, and output the image data subjected to the image processing to another device (such as a display device, for example) or store the image data in a predetermined storage section (not illustrated).

Specifically, the control unit is mainly formed with, for example, a control section including a central processing unit (CPU) that performs various types of arithmetic processing, read only memory (ROM) that stores data in advance, and random access memory (RAM) that temporarily stores data. The control unit further includes an interface capable of exchanging control signals and various types of data with the slide storage 100, the image capturing block 200, and the slide handler 300.

In the present embodiment, the image capturing system 10 according to the present embodiment and the devices included in the image capturing system 10 are not limited to those illustrated in FIGS. 2 to 4, and there may be still other devices or other elements, for example.

<1.3 Background of Creation>

Next, the background of the creation of the embodiment of the present disclosure by the present inventors will be described. As described above, the image capturing system 10 according to the present embodiment can automatically and sequentially perform digital image capturing on several hundreds of glass slides 800 stored in the slide storage 100. Therefore, the image capturing system 10 according to the present embodiment is assumed to be used, for example, at night when laboratory technicians are absent. The use in this manner is expected to shorten the inspection and diagnosis time, reduce the labor burden on the laboratory technicians, and make up for the shortage of the laboratory technicians.

However, according to a result of a hearing survey for laboratory technicians and the like actually conducted by the present inventors, it was found that while the system has been used at night when laboratory technicians are absent as described above, the conventional image capturing system 10 has the following problems. For example, with the conventional image capturing system 10, when the glass slide 800 is conveyed, the slide handler 300 cannot appropriately grip the glass slide 800, resulting in a failure such as falling or breakage of the glass slide 800. In addition, it has been found that, the damage occurring to the glass slide 800 in this manner can lead to the loss of a valuable biological specimen mounted on the glass slide 800, hindering prompt examination and diagnosis, finally leading to hinderance of prompt treatment.

In addition, according to the investigation of the present inventors, it has been found that, in the conventional image capturing system 10, in a case where a large amount of the glass slide 800 is continuously captured at night, some component of the slide handler 300 are rubbed against and abraded by the glass slide 800 in about one day to several days, making it necessary to replace the component. In addition, it has been found that there is a case where the slide handler 300 cannot appropriately grip the glass slide 800 due to a sudden abrasion of the component during continuous image capturing. The conventional slide handler 300 has the component in contact with the glass slide 800 being formed of a material such as resin, leading to the occurrence of abrasion in a short period.

Furthermore, in a dimensional standard (width and thickness in Y-axis direction (longitudinal direction) and X-axis direction (lateral direction)) in the glass slide 800, dimensional variations allowed by the standard are as large as about several mm. Therefore, the slide handler 300 is required to have a specification capable of managing dimensional variations to some extent. However, there are few conventional slide handlers 300 capable of appropriately managing such dimensional variations, making it also difficult for the slide handler 300 to appropriately grip the glass slide 800.

For example, the conventional slide handler 300 (for example, Patent Literature 1) adopts a rigid structure capable of gripping only the glass slide 800 having predetermined dimensions, and thus, cannot appropriately grip the glass slide 800 having different sizes and can even break the glass slide 800 with high probability at the time of gripping.

The present inventors have intensively studied the conventional image capturing system 10 to settle this situation, and have found that the failure on the slide handler 300 in appropriately gripping the glass slide 800 is mainly caused by the characteristics of the glass slide 800.

First, the glass slide 800 is very hard (for example, about 550 HV) in characteristic. Therefore, gripping the glass slide 800 with a strong force by the slide handler 300, the glass slide 800 might be broken even though falling is prevented.

In addition, since the biological specimen is mounted in the central portion of the glass slide 800, the slide handler 300 cannot directly grip the mounting region of the biological specimen on the glass slide 800. Furthermore, the glass slide 800 may have, at its end for example, a portion such as a region called a frosted portion where a biological specimen is not to be mounted and a label portion 806 in which identification information of the glass slide 800 is to be described. However, not all types of the glass slide 800 have such a portion. Consequently, it is not preferable that the slide handler 300 perform such gripping as to sandwich the front surface and the back surface of the glass slide 800 from above and below. In addition, such gripping by the slide handler 300 can cause a situation in which an adhesive or the like used for enclosing the biological specimen with a cover slip (not illustrated) ooze out on surfaces of the glass slide 800, leading to contamination of the slide handler 300 by the adhesive or the like.

For example, the conventional slide handler 300 (for example, Patent Literature 2 described above) adopts a gripping form in which the label portion 806 at the end of the glass slide 800 is sandwiched from above and below. Therefore, the slide handler 300 has had a situation in which a part of the slide handler 300 is contaminated with the adhesive of the label portion 806 of the glass slide 800.

Furthermore, in another conventional slide handler 300 (for example, Patent Literature 3 described above), the glass slide 800 is fixed by air suction. However, this method is unstable as compared with direct gripping, having a higher possibility of dropping the glass slide 800 during conveyance.

To cope with this, there is a conceivable method, as a form of gripping the slide handler 300, of sandwiching the glass slide 800 from both sides thereof so as to come in contact with end surfaces (edges) of the glass slide 800 in the Y-axis direction (longitudinal direction) or the X-axis direction (lateral direction). Such a carrying form, however, makes it difficult to carry with an appropriate force, and the glass slide 800 might be broken when gripped with a strong force. In addition, the glass slide 800 and the slide handler 300 can rub against each other at the time of gripping, and this can cause fine glass powder generated from the glass slide 800 to adversely affect the mechanism of the slide handler 300, leading to a conveyance error.

Furthermore, the glass slide 800 is often unprocessed after being cut out from the glass plate as described above, and thus, end surfaces (edges) 802a, 802b, 804a, and 804b are often not smooth (for example, with burrs). Due to the high hardness of the glass slide 800, the burr of the glass slide 800 and the slide handler 300 rub each other, increasing the likelihood of abrasion in components of the slide handler 300. Furthermore, the burr, after brought into contact with the slide handler 300, leads to occurrence of a crack shaped like a seashell on the end surfaces 802a, 802b, 804a, and 804b of the glass slide 800.

In view of such a situation, the present inventors have created an embodiment of the present disclosure described below. With the embodiment of the present disclosure, the problem in the conveyance by the slide handler 300 caused by the characteristics of the glass slide 800 as described above can be solved, leading to achievement of appropriate conveyance of the glass slide 800. According to the embodiment of the present disclosure, digital image capturing can be more reliably performed automatically and sequentially on hundreds of glass slides 800 stored in the slide storage 100 while avoiding damage on the biological specimen. Consequently, by using the image capturing system 10 according to the present embodiment, for example, at night when the laboratory technicians are absent, it is possible to shorten the examination diagnosis time, reduce the labor burden on the laboratory technicians, and make up for the shortage of the laboratory technicians.

<1.4 Overview of Embodiments of Present Disclosure>

Next, an overview of embodiments of the present disclosure created by the present inventors will be described. The slide handler 300 according to the embodiments of the present disclosure described below mainly includes three elements for appropriately gripping the glass slide 800. Specifically, the first element makes it possible to appropriately grip the hard and fragile glass slide 800 and reduce abrasion of the slide handler 300 itself. The second element makes it possible to pre-detect the dimension of the glass slide 800 having a large dimensional variation and recognize the glass slide 800 deviating from the dimensional standard as an error before the glass slide 800 is gripped, leading to the reduction of the conveyance errors. Furthermore, the third element allows the glass slide 800 to be guided and gripped in an appropriate position. Hereinafter, such three elements will be sequentially described as first to third embodiments of the present disclosure.

### 2. First Embodiment

<2.1 Detailed Configuration>

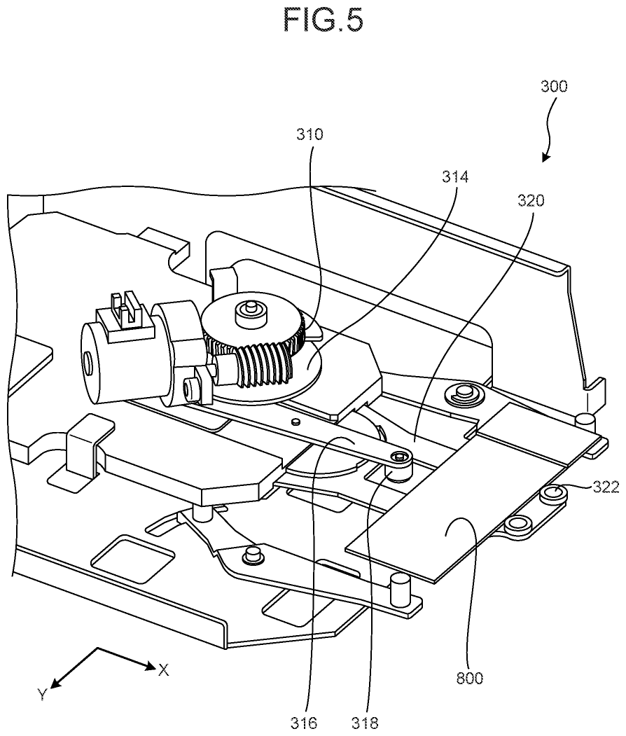

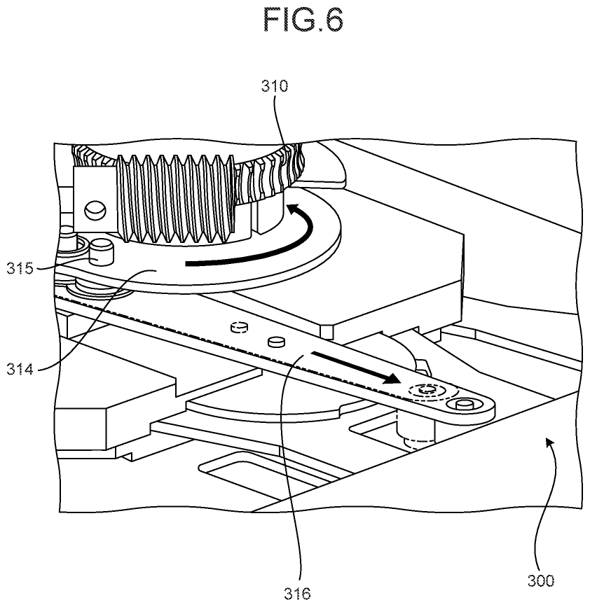

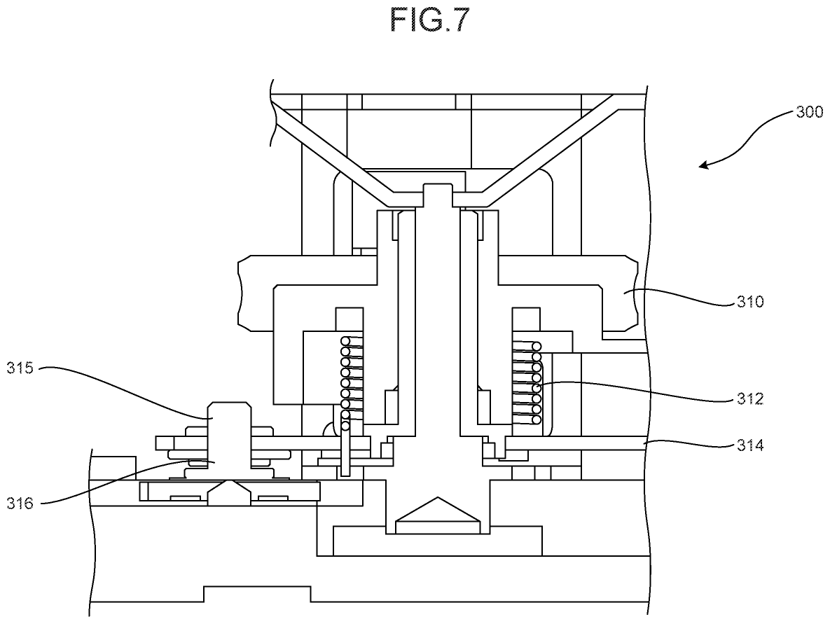

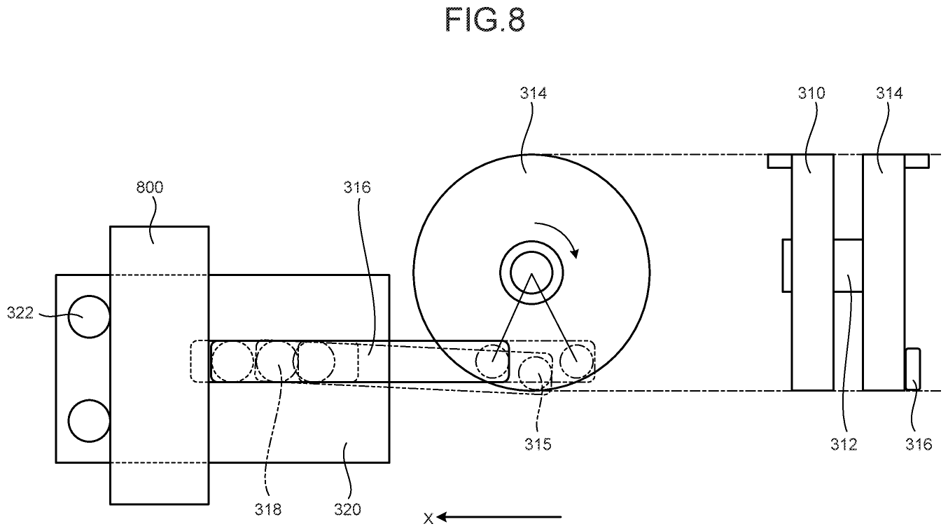

First, with reference to FIGS. 5 to 8, as a first embodiment of the present disclosure, the following will describe a configuration, as the first element, capable of appropriately gripping the hard and fragile glass slide 800 with less abrasion of the slide handler 300 itself. FIGS. 5 and 6 are perspective views illustrating the slide handler 300 according to the present embodiment. FIG. 7 is a cross-sectional view illustrating the slide handler 300 according to the present embodiment. FIG. 8 is a diagram illustrating an operation of the slide handler 300 according to the present embodiment.

As illustrated in FIG. 5, the slide handler 300 according to the present embodiment includes a catcher arm (arm member) 316 that is provided to be movable in the X-axis direction (first direction) on a plane, the catcher arm 316 including, at its distal end, a contact member (first contact member) 318 that comes into contact with an end surface (first end surface) 802a of the glass slide 800. The slide handler 300 further includes a handler (support plate) 320 that has two contact members (second contact members) 322 each of which coming in contact with the other end surface (second end surface) 802b of the glass slide 800 located opposite to the end surface 802a in the X-axis direction, and supports the glass slide 800 from below. Furthermore, in the present embodiment, the handler 320 is provided to be movable in the X-axis direction by a driver (not illustrated). In the present embodiment, the number of the contact members 322 provided in the handler 320 is not limited to two as illustrated in FIG. 5, and one or a plurality of the contact members may be provided.

As illustrated in FIG. 5, in the present embodiment, the catcher arm 316 moves to a position where the contact member 318 and the contact member 322 simultaneously come into contact with the glass slide 800, making it possible to grip the glass slide 800. In the present embodiment, the glass slide 800 is supported from below by the handler 320, making it less likely to drop the glass slide 800 at the time of conveyance. In addition, with the present embodiment adopting the form in which the glass slide 800 is supported from below by the handler 320, each glass slide 800 can be appropriately gripped even with a large variation in the thickness of the glass slide 800.

In the present embodiment, as illustrated in FIG. 5, the slide handler 300 includes a driver that drives the catcher arm 316 so as to be movable in the X-axis direction. The driver includes: a worm wheel (rotary disc) 310 having a circular shape and driven by a motor; and a catcher arm drive plate (drive member) 314 having a disc shape and configured to rotate with the rotation of the worm wheel 310, thereby moving the catcher arm 316 in the X-axis direction. Specifically, as illustrated in FIG. 6, the worm wheel 310 rotates about its own central axis as a rotation axis (rotation), which allows the catcher arm drive plate 314 to also rotate about its own central axis as a rotation axis (rotation). Then, the catcher arm 316, connected to the catcher arm drive plate 314 by a connection member 315, can move in the X-axis direction by the rotation of the catcher arm drive plate 314.

Additionally, in order to appropriately grip the glass slide 800 which has a large dimensional variation and is hard and fragile, the present embodiment provides a biasing member between the worm wheel 310 and the catcher arm drive plate 314. Specifically, in the present embodiment, as illustrated in FIG. 6 which is a cross-sectional view when the slide handler 300 is cut along a plane perpendicular to a horizontal plane, there is provided a torsion coil spring 312 as the biasing member between the worm wheel 310 and the catcher arm drive plate 314.

In the present embodiment, the torsion coil spring 312 can transmit the rotation of the worm wheel 310 to the catcher arm drive plate 314 to rotate the catcher arm drive plate 314. Furthermore, the movement of catcher arm 316 is stopped by the glass slide 800 when the catcher arm 316 moves to a position where the contact member 318 and the contact member 322 simultaneously come in contact with the glass slide 800, enabling the torsion coil spring 312 to generate a biasing force to move the catcher arm 316 in the X-axis direction.

Accordingly, by the biasing of the torsion coil spring 312 in the present embodiment, the glass slide 800 can be sandwiched by the contact member 318 and the contact member 322 with a more appropriate force. In the present embodiment, the biasing member is not limited to the use of the torsion coil spring 312, and may be implemented by using an elastic body such as a tension coil spring, a compression coil spring, a leaf spring, or rubber.

<2.2 Operation>

Details of the operation of the slide handler 300 according to the present embodiment will be described with reference to FIG. 8. FIG. 8 schematically illustrates, on its right side, a cross sectional view of the driver of the slide handler 300 according to the present embodiment; FIG. 8 schematically illustrates, on its left side, a planar view of the slide handler 300 according to the present embodiment.

First, the worm wheel 310 and the catcher arm drive plate 314 rotate in synchronization via the torsion coil spring 312. Subsequently, the rotation of the catcher arm drive plate 314 allows the catcher arm 316 to move in the X-axis direction.

Next, when the contact member 318 at the distal end of the catcher arm 316 comes into contact with the glass slide 800, the movement of the catcher arm 316 stops, and together with this, the rotation of the catcher arm drive plate 314 also stops. On the other hand, the rotation of the worm wheel 310 does not stop at this time. Accordingly, the torsion coil spring 312 provided between the worm wheel 310 and the catcher arm drive plate 314 is pressed to generate a biasing force in the X-axis direction. In the present embodiment, the biasing force generated in this manner (spring gripping force) is used to appropriately sandwich the glass slide 800 between the contact member 318 and the contact member 322.

Next, the rotation of the worm wheel 310 stops at a predetermined position. At this time, a part of the force to be applied to the glass slide 800 is absorbed due to the elasticity of the torsion coil spring 312, making it possible to avoid application of a strong impact force to the glass slide 800. This enables the slide handler 300 to grip the hard and fragile glass slide 800 with a buffering effect in the present embodiment, leading to avoidance of breaking the glass slide. That is, according to the present embodiment, the glass slide 800 can be appropriately gripped by the slide handler 300.

<2.3 Contact Members 318 and 322>

Furthermore, the present embodiment can reduce the abrasion of components of the slide handler 300 as described above. Hereinafter, details of such a configuration will be described.

As described above, the contact members 318 and 322 according to the present embodiment come in contact with the hard glass slide 800 and rub each other, and thus are highly likely to be abraded. Therefore, in the present embodiment, by making the contact side surfaces of the contact members 318 and 322 harder than the glass slide, it is possible to reduce the abrasion of the members.

Specifically, referring back to FIG. 5, the contact members 318 and 322 have a shape of a cylinder with their side surfaces coming into contact with the end surfaces 802a and 802b of the glass slide 800, respectively. The contact members 318 and 322, formed in such a shape of a cylinder, makes it possible to reduce the contact area with the glass slide 800. By reducing the contact area with the glass slide 800, the glass slide 800 can be sandwiched between the contact member 318 and the contact member 322 while avoiding contamination of the contact members 318 and 322 with fine dust attached to the glass slide 800. In addition, it is preferable that the contact members 318 and 322 be provided rotatably (rotationally) about the central axis of the cylinder so that the glass slide 800 can move in the Y-axis direction perpendicular to the X-axis direction on a plane.

Furthermore, in the present embodiment, the side surfaces of the contact members 318 and 322 are formed of a material subjected to nitriding treatment. For example, the side surfaces of the contact members 318 and 322 are formed of stainless steel subjected to nitriding treatment. Specifically, by applying nitriding treatment on the surface of stainless steel, it is possible to obtain a surface having a hardness of, for example, a Vickers hardness of about 1000 HV as compared with the glass slide 800 (for example, the Vickers hardness is 550 HV.). The present embodiment is not limited to the nitriding treatment, and any method is applicable without limitation as long as the side surfaces of the contact members 318 and 322 can be treated to have higher hardness than the glass slide 800. For example, the side surfaces of the contact members 318 and 322 according to the present embodiment may be subjected to chromium carbide plating, nickel plating, boron-containing nickel plating, or ceramic coating. In order to improve sliding between the glass slide 800 and the contact members 318 and 322, the side surfaces of the contact members 318 and 322 may be further subjected to blast treatment or fluororesin coating.

In the present embodiment, the contact members 318 and 322 themselves may be formed of hard ceramics such as alumina (for example, about 1600 HV), zirconia (for example, about 1300 HV), and diamond-like carbon (DLC) (for example, 3000 HV or more).

In the present embodiment, with high-hardness side surfaces of the contact members 318 and 322, it is possible to reduce abrasion of the contact members 318 and 322 due to the contact or rubbing with the glass slide 800. Therefore, according to the present embodiment, even in a case where a large amount of the glass slide 800 is continuously captured, it is possible to reduce the number of times of replacement of the contact members 318 and 322 due to abrasion of the contact members 318 and 322. This leads to reduction of the number of times of maintenance of the slide handler 300, making it possible to suppress an increase in operating cost of the image capturing system 10. Furthermore, according to the present embodiment, it is possible to prevent occurrence of a conveyance error of the glass slide 800 due to abrasion of the contact members 318 and 322.

### 3. Second Embodiment

<3.1 Detailed Configuration>

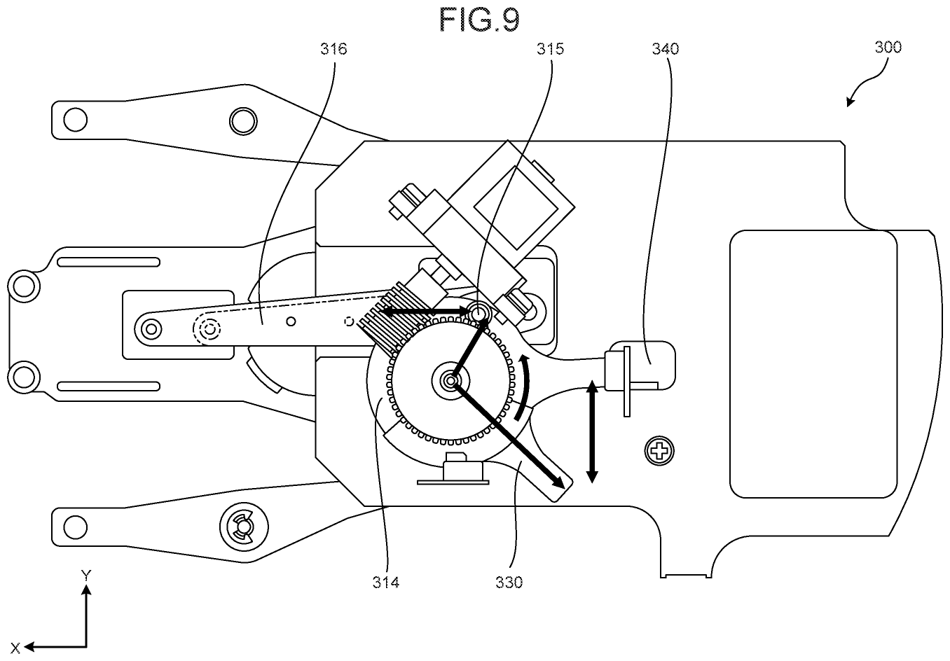

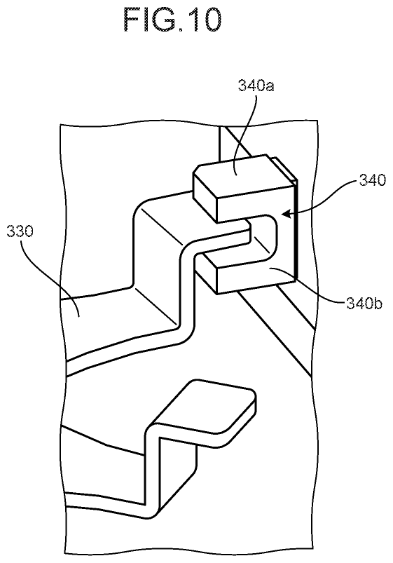

Next, with reference to FIGS. 9 and 10, a second embodiment of the present disclosure will be described as a configuration, being the second element, capable of reducing conveyance errors by pre-detecting the dimension of the glass slide 800 having a large dimensional variation, and recognizing the detected dimension as an error before gripping the glass slide 800 deviating from the dimensional standard. FIG. 9 is a diagram illustrating a detection mechanism according to the present embodiment. FIG. 10 is a diagram illustrating the detector 340 according to the present embodiment.

In the present embodiment, the slide handler 300 has a detection mechanism that detects, before gripping, the glass slide 800 having a small dimension outside the standard. In the present embodiment, for example, the small glass slide 800 detected by the detection mechanism is processed not to be gripped by the slide handler 300 and not to be transferred to the next process (image capturing block 200). In this manner, the small glass slide 800, which is difficult to handle by the slide handler 300, is not to be gripped in the present embodiment, making it possible to prevent an accident such as falling of the glass slide 800, leading to prevention of occurrence of damage to the biological specimen mounted on the glass slide 800.

More specifically, the slide handler 300 according to the present embodiment includes a detection mechanism that detects the width of the glass slide 800 in the X-axis direction (lateral direction). The detection mechanism includes: a detector (light detector) 340 (refer to FIG. 10) having an illuminator 340a and a light receiver 340b provided to face each other; and a light shielding member 330 connected to the catcher arm drive plate 314 and capable of blocking light from the illuminator 340a. For example, in the present embodiment, such a detection mechanism is used to detect the glass slide 800 having a width smaller by about 0.5 mm to several mm than the dimension conveyable by the slide handler 300.

However, in order to accurately detect a difference in length of about 0.5 mm to several mm by the detection mechanism, it is often necessary, due to manufacturing variations, to manually adjust the detection mechanism and perform a shipping inspection at the time of shipping the slide handler 300.

To handle this issue, the present embodiment has adopted a structure capable of detecting an enlarged width of the glass slide 800 instead of detecting the real size so that the detection mechanism can accurately detect a small difference in the width of the glass slide 800 even with manufacturing variations of the slide handler 300. With this structure, the present embodiment can eliminate the necessity of adjustment or inspection of the detection mechanism at the time of shipment, making it possible to suppress an increase in manufacturing time and manufacturing cost of the slide handler 300.

Specifically, as illustrated in FIG. 9, the present embodiment forms the light shielding member 330 by using a protrusion protruding from the circumference of the catcher arm drive plate 314. As described above, the catcher arm drive plate 314 rotates until the catcher arm 316 comes into contact with the glass slide 800 after moving in the X-axis direction (that is, the catcher arm 316 moves by a distance corresponding to the width of the glass slide 800). Accordingly, the light shielding member 330 protruding from the catcher arm drive plate 314 also rotates by the rotation angle of the catcher arm drive plate 314.

In the present embodiment, the light shielding member (protrusion) 330 is provided to set the length from the distal end of the light shielding member (protruding portion) 330 to the center of the catcher arm drive plate 314 to be longer than the radius of the catcher arm drive plate 314. Furthermore, in the present embodiment, the length from the distal end of the light shielding member 330 to the center of the catcher arm drive plate 314 is preferably twice or more the radius of the catcher arm drive plate 314. With this setting, when the length from the distal end of the light shielding member 330 to the center of the catcher arm drive plate 314 is X times the radius of the catcher arm drive plate 314, the displacement of the distal end of the light shielding member 330 in the Y-axis direction is to be enlarged to X times the displacement of the catcher arm 316 in the X-axis direction according to the relationship of similarity.

In the present embodiment, as illustrated in FIG. 10, with the distal end of the light shielding member 330 located between the illuminator 340a and the light receiver 340b of the detector 340, it is possible to block the light from the illuminator 340a and disable light detection at the light receiver 340b. Accordingly, in the present embodiment, when light detection fails at the detector 340, the glass slide 800 can be determined as the glass slide 800 having a small dimension out of the standard. That is, in the present embodiment, by adjusting the ratio between the length of the light shielding member 330 and the radius of the catcher arm drive plate 314, it is possible to enlarge the displacement of the catcher arm 316 in the X-axis direction detected as the displacement of the light shielding member 330. Therefore, in the present embodiment, it is possible to detect, by the detector 340, an enlarged displacement, which is obtained by enlarging the displacement of the catcher arm 316 in the X-axis direction and which might be small, making it possible for the detection mechanism to accurately detect the glass slide 800 having a small dimension outside the standard.

As described above, in the present embodiment, the slide handler 300 has a detection mechanism that detects, before gripping, the glass slide 800 having a small dimension outside the standard. In the present embodiment, for example, the small glass slide 800 detected by the detection mechanism is processed not to be gripped by the slide handler 300 and not to be transferred to the next process (image capturing block 200). In this manner, the small glass slide 800, which is difficult to handle by the slide handler 300, is not to be gripped in the present embodiment, making it possible to prevent an accident such as falling of the glass slide 800, leading to prevention of occurrence of damage to the biological specimen mounted on the glass slide 800.

Furthermore, in the present embodiment, it is possible to detect, by the detector 340, an enlarged displacement, which is obtained by enlarging the displacement of the catcher arm 316 in the X-axis direction and which might be small, making it possible for the detection mechanism to accurately detect the glass slide 800 having a small dimension outside the standard. Accordingly, in the present embodiment, even with the presence of manufacturing variation of the slide handler 300, the detection mechanism can accurately detect a small difference in the width of the glass slide 800. As a result, the present embodiment can eliminate the necessity of adjustment or inspection of the detection mechanism at the time of shipment, making it possible to suppress an increase in manufacturing time and manufacturing cost of the slide handler 300.

<3.2 Modification>

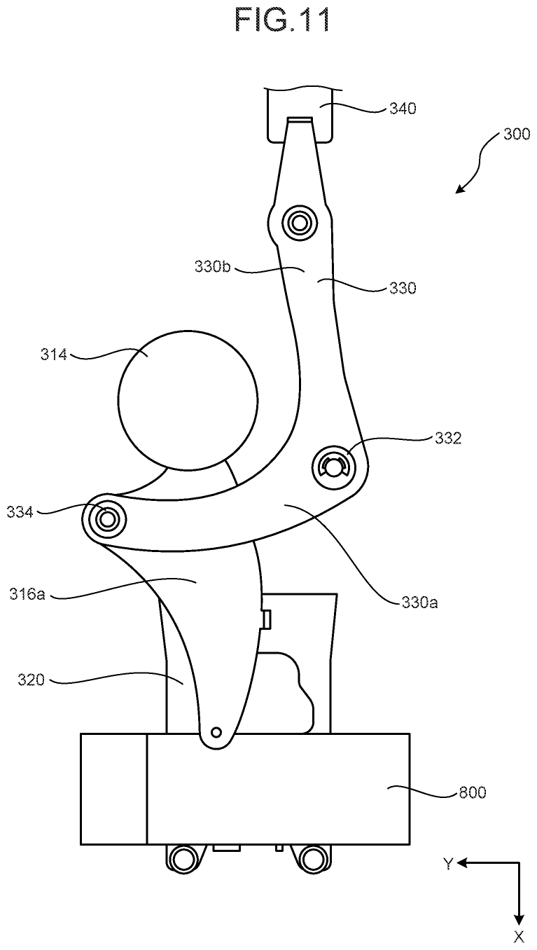

Furthermore, a detection mechanism according to a modification of the present embodiment will be described with reference to FIG. 11. FIG. 11 is a diagram illustrating a detection mechanism according to a modification of the present embodiment.

As illustrated in FIG. 11, in the present modification, the light shielding member 330 is an L-shaped member having a short rectangular portion 330a and a long rectangular portion 330b connected via a fulcrum 332. An end of the short rectangular portion 330a is connected to the catcher arm 316a that moves with the rotation of the catcher arm drive plate 314 by a connection member 324, and rotates about the fulcrum 332 as a rotation center together with the rotation of the catcher arm drive plate 314. Furthermore, an end of the long rectangular portion 330b capable of blocking the light from the illuminator 340a rotates about the fulcrum 332 as the rotation center in accordance with the rotation of the end of the short rectangular portion 330a. Also in the present modification, the length of the long rectangular portion 330b is preferably longer than the length of the short rectangular portion 330a, and the length of the long rectangular portion 330b is preferably twice or more the length of the short rectangular portion 330a.

### 4. Third Embodiment

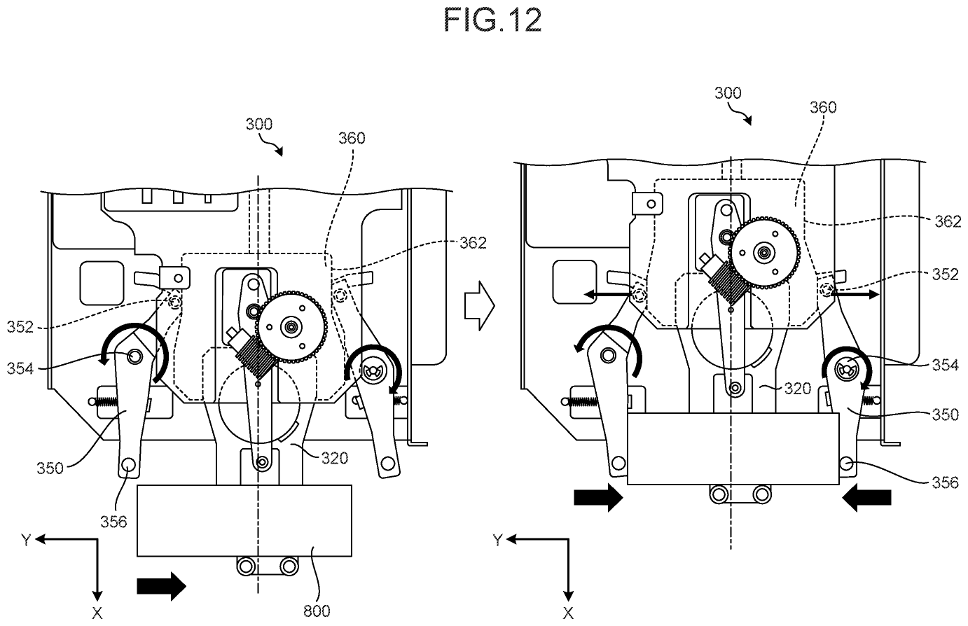

Next, as a third embodiment of the present disclosure, a configuration in which the glass slide 800 can be guided and gripped at an appropriate position, which is the third element, will be described with reference to FIG. 12. FIG. 12 is a diagram illustrating a guide mechanism according to the present embodiment.

In the embodiment described above, the slide handler 300 grips the glass slide 800 to be sandwiched from both sides in the Y-axis direction (longitudinal direction). However, with such a gripping form, the glass slide 800 might be displaced in the Y-axis direction, leading to a failure in appropriately conveying the glass slide 800.

In view of this, the present embodiment provides a variable guide mechanism that guides the glass slide 800 so as to be positioned at a central portion of the handler 320. Furthermore, with such a guide mechanism according to the present embodiment, it is possible to correct the deviation in orientation due to the conveyance of the glass slide 800, it is possible to improve the accuracy of the conveyance of the glass slide 800 to the image capturing block 200 and the slide storage 100.

Specifically, as illustrated in FIG. 12, the slide handler 300 includes a guide mechanism that guides the glass slide 800 to a predetermined position of the handler 320 by coming in contact with end surfaces of the glass slide 800, specifically an end surface (third end surface) 804a and an end surface (fourth end surface) 804b located opposite to the end surface 804a.

Specifically, the guide mechanism includes a pair of guide members 350, and each of the guide members 350 is rotatably provided around a fulcrum (rotation fulcrum) 354 provided at a central portion thereof as a rotation center. One end 352 of each guide member 350 is moved in the Y axis direction by a guide driver 360. Specifically, the guide driver 360 is provided to be movable in the X-axis direction. Therefore, when the guide driver 360 moves in the X axis direction, the one end 352 can move, along with the movement, in the Y axis direction by performing sliding movement (coming in contact) with a side surface 362 of the guide driver 360, provided obliquely with respect to the X axis direction.

Furthermore, a contact member (third contact member) 356 that comes in contact with the glass slide 800 is provided at the other end of each guide member 350. For example, the contact member 356 has a shape of a cylinder, and its side surface comes in contact with the end surfaces 804a and 804b of the glass slide 800. With the contact member 356 formed in this shape, the contact area with the glass slide 800 can be reduced. Furthermore, the contact member 356 may be provided so as to be rotatable (rotational) about the central axis of the cylinder so that the glass slide 800 can move in the X-axis direction on a plane. Furthermore, in the present embodiment, the side surface of the contact member 356 may be formed of a material subjected to nitriding treatment, or a hard ceramic.

As described above, in the present embodiment, there is provided a variable guide mechanism that guides the glass slide 800 so as to be positioned at the central portion of the handler 320. Accordingly, with such a guide mechanism according to the present embodiment, it is possible to correct the deviation in orientation due to the conveyance of the glass slide 800, it is possible to improve the accuracy of the conveyance of the glass slide 800 to the image capturing block 200 and the slide storage 100.

### 5. Fourth Embodiment

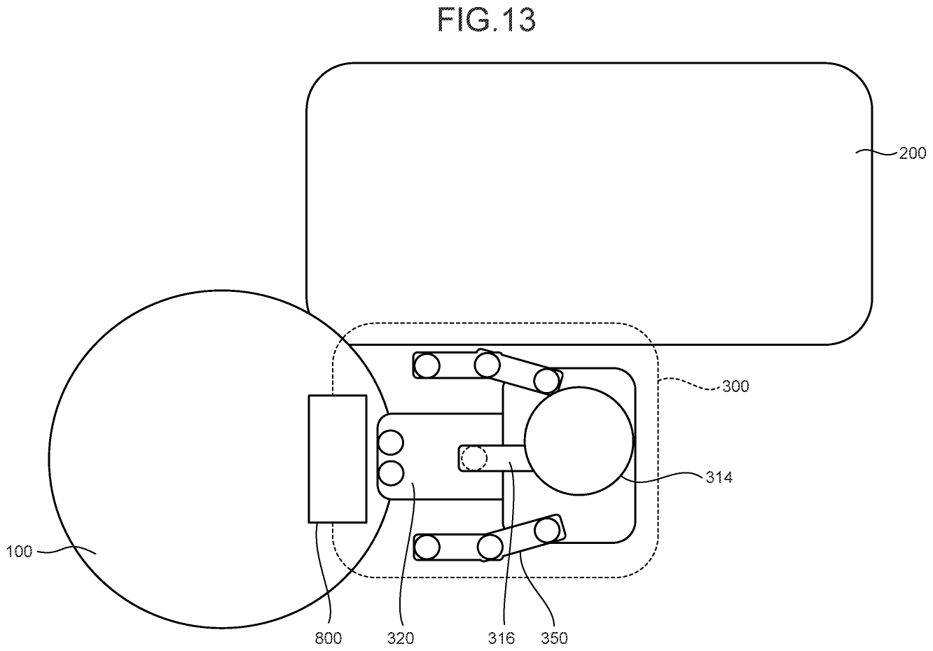

Next, as a fourth embodiment of the present disclosure, operations of the slide handler 300 according to the embodiment of the present disclosure will be described with reference to FIGS. 13 to 18. FIGS. 13 to 18 are diagrams illustrating operations of the slide handler 300 according to the present embodiment.

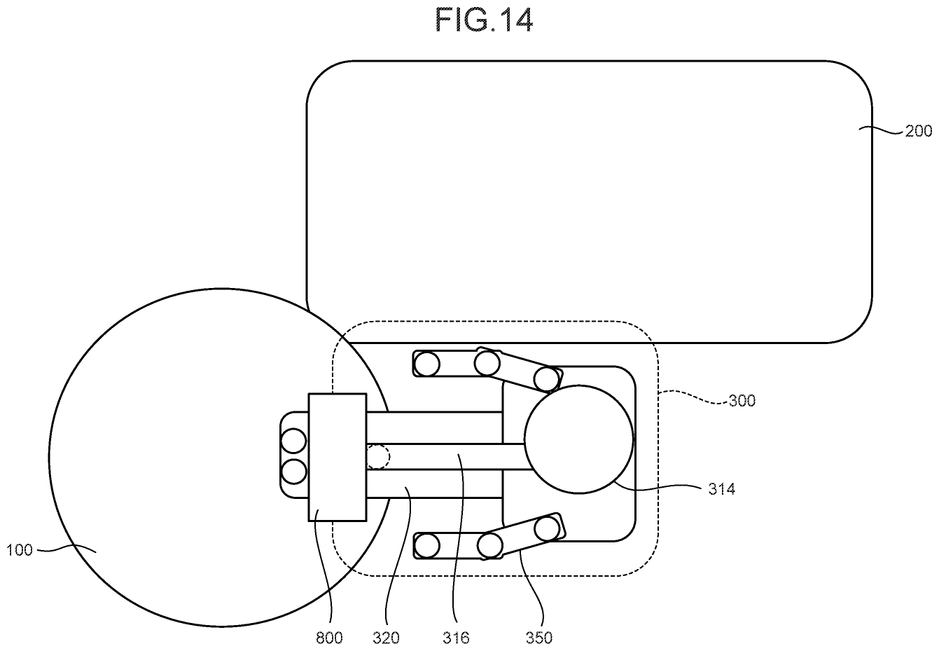

First, as illustrated in FIGS. 13 and 14, the slide handler 300 extends the catcher arm 316 and the handler 320 toward the slide storage 100 in order to grip the glass slide 800 stored in the slide storage 100.

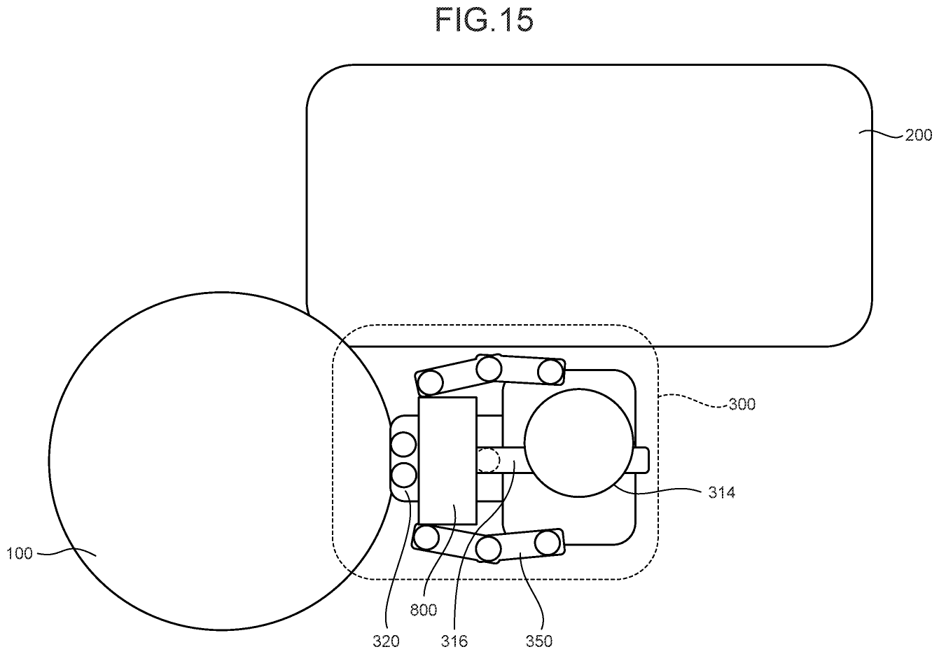

Next, as illustrated in FIG. 15, the slide handler 300 grips the glass slide 800 so as to be sandwiched between the catcher arm 316 and the handler 320.

Next, as illustrated in FIG. 15, the slide handler 300 guides the glass slide 800 to an appropriate position on the handler 320 by sandwiching the glass slide 800 between the pair of guide members 350, and thereafter extracts the glass slide 800 from the slide storage 100.

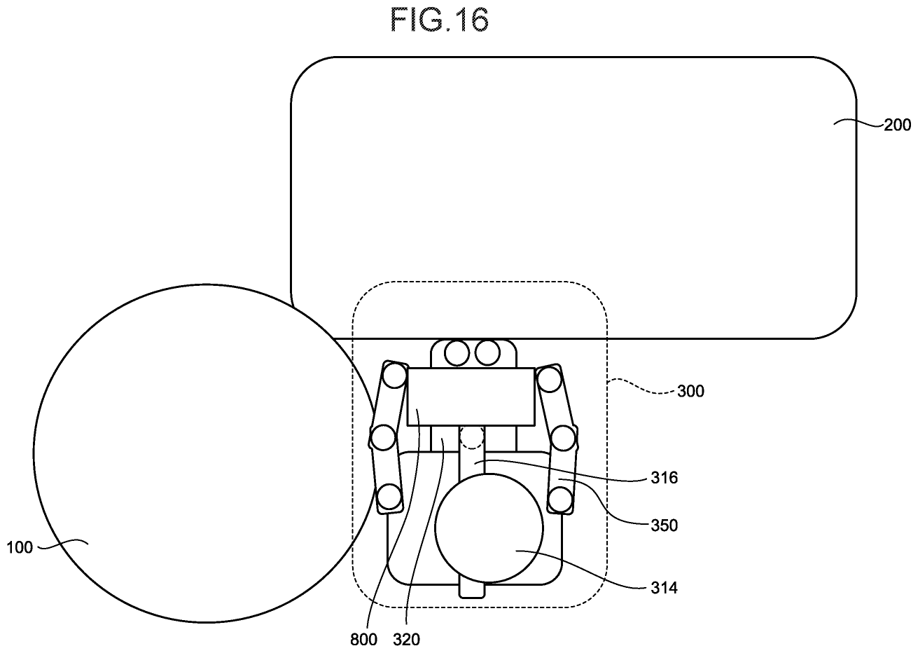

Next, as illustrated in FIG. 16, the slide handler 300 rotates 90 degrees while gripping the glass slide 800 in order to convey the glass slide 800 to the image capturing block 200.

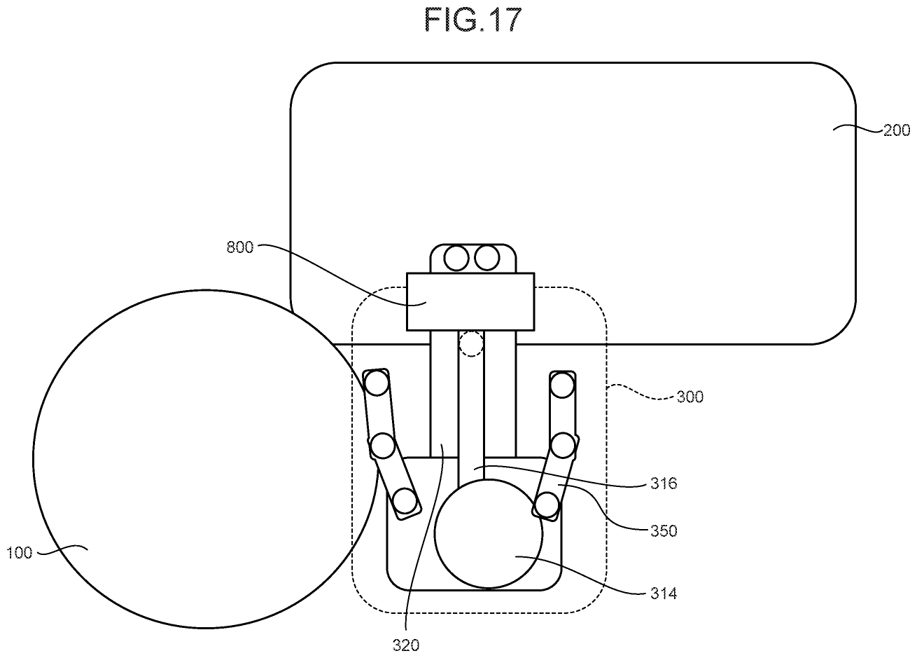

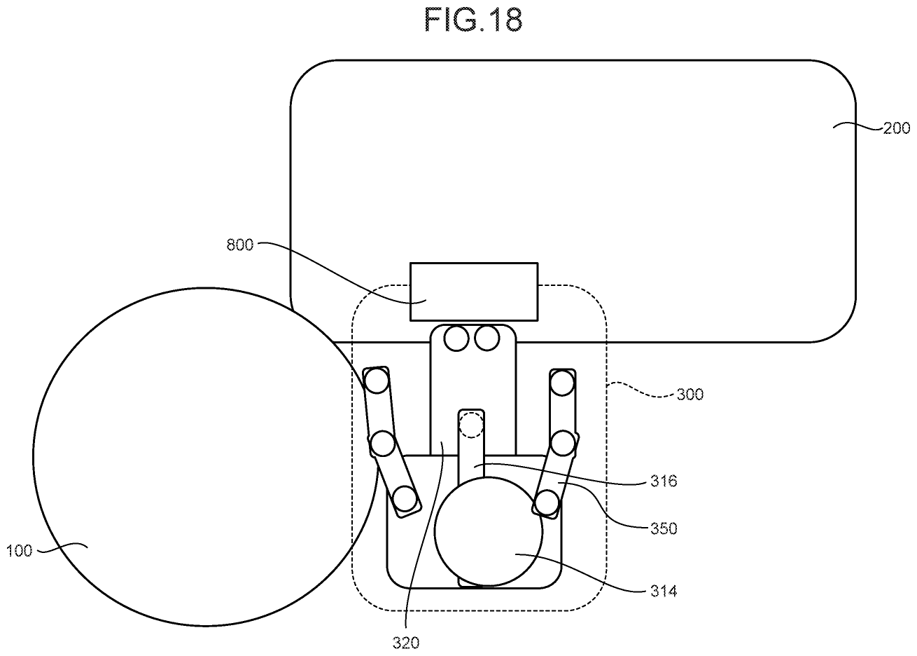

Subsequently, as illustrated in FIGS. 17 and 18, slide handler 300 extends the catcher arm 316 and handler 320 toward the image capturing block 200, and places the glass slide 800 on the image capturing block 200. At this time, the pair of guide members 350 is released from a state of gripping the glass slide 800.

As described above, the slide handler 300 according to the embodiment of the present disclosure can convey the glass slide 800 from the slide storage 100 to the image capturing block 200.

### 6. Summary

As described above, with the embodiment of the present disclosure, it is possible to solve the problem in the conveyance of the slide handler 300 caused by the characteristics of the glass slide 800 as described above, leading to achievement of appropriate conveyance of the glass slide 800. According to the present embodiment, digital image capturing can be more reliably performed and sequentially on hundreds of glass slides 800 stored in the slide storage 100 while avoiding problems such as damage to the biological specimen. Consequently, when the image capturing system 10 according to the present embodiment is used at night when the laboratory technicians are absent, for example, it is possible to shorten the examination diagnosis time, reduce the labor burden on the laboratory technicians, and make up for the shortage of the laboratory technicians.

Furthermore, with the embodiment of the present disclosure, the glass slide 800 can be appropriately conveyed while suppressing an increase in the number of components, leading to suppression of an increase in manufacturing cost and size of the slide handler 300.

In the embodiment of the present disclosure described above, the imaging target is not limited to the biological specimen mounted on the glass slide 800, and may be an object to be observed having a form similar to the glass slide 800 or an object to be observed mounted on a substrate (not illustrated) having a form similar to the glass slide 800, with no particular limitation. Furthermore, the embodiments of the present disclosure described above are not limited to application to medical use, research, or the like, and are not particularly limited as long as the technology is used in highly accurate analysis or the like using an image.

### 7. Examples of Application to Products

The technology according to the present disclosure is applicable to various products. For example, the technology according to the present disclosure may be applied to a pathological diagnosis system that performs diagnosis of a lesion by observing cells or tissues collected from a patient by a doctor or the like, a support system for the diagnosis, or the like (hereinafter, referred to as a diagnosis support system.). The diagnosis support system may be a whole slide imaging (WSI) system that diagnoses or supports a lesion on the basis of an image acquired using a digital pathology technology.

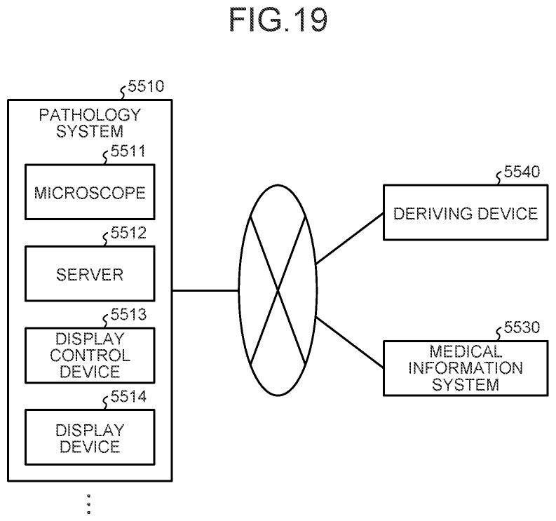

FIG. 19 is a diagram illustrating an example of a schematic configuration of a diagnosis support system 5500 to which the technology according to the present disclosure is applied. As illustrated in FIG. 19, the diagnosis support system 5500 includes one or more pathology systems 5510. The diagnosis support system 5500 may further include a medical information system 5530 and a deriving device 5540.

Each of the one or more pathology systems 5510 is a system mainly used by a pathologist, and is applied to a laboratory and a hospital, for example. Each pathology system 5510 may be introduced into different hospitals, and is connected to the medical information system 5530 and the deriving device 5540 via various networks such as a wide area network (WAN) (including the Internet), a local area network (LAN), a public line network, and a mobile communication network.

Each pathology system 5510 includes a microscope 5511 (in particular, a microscope used in combination with a digital image capturing technique), a server 5512, a display control device 5513, and a display device 5514.

The microscope 5511 has a function of an optical microscope, and captures an image of an observation target placed on a glass slide to acquire a pathological image which is a digital image. The observation target is, for example, a tissue or cell sampled from a patient, and may be a piece of organ tissue, saliva, blood, and the like. For example, the microscope 5511 functions as the image capturing system 10 illustrated in FIG. 19.

The server 5512 stores and preserves a pathological image acquired by the microscope 5511 in a storage section (not illustrated). When having received a viewing request from the display control device 5513, the server 5512 retrieves a pathological image from the storage section (not illustrated) and transmits the retrieved pathological image to the display control device 5513. For example, the server 5512 may function as a control unit according to the embodiment of the present disclosure.

The display control device 5513 transmits a request for viewing a pathological image received from a user to the server 5512. The display control device 5513 displays the pathological image received from the server 5512 on the display device 5514 using liquid crystal, electro-luminescence (EL), cathode ray tube (CRT), or the like. The display device 5514 may be compatible with 4K or 8K, and is not limited to one device, and may be a plurality of devices.

Here, when the observation target is a solid material such as a piece of organ tissue, the observation target may be, for example, a stained thin tissue section. The thin tissue section may be prepared by slicing a block tissue piece cut out from a specimen such as an organ. In addition, at the time of slicing, the block tissue piece may be fixed and embedded with paraffin or the like.

For the staining of the thin tissue section, various types of staining may be applied, examples of this including: general staining indicating the morphology of the tissue, such as Hematoxylin-Eosin (HE) staining; special staining; and immunostaining or fluorescent immunostaining indicating the immune state of the tissue, such as Immunohistochemistry (IHC) staining. At that time, one thin tissue section may be stained using a plurality of different reagents, or two or more thin tissue sections (also referred to as adjacent thin tissue sections) continuously cut out from the same block tissue piece may be stained using different reagents.

The microscope 5511 may include a low-resolution image capturing section for image capturing with low resolution and a high-resolution image capturing section for image capturing with high resolution. Note that the low-resolution image capturing section and the high-resolution image capturing section described above may include different optical systems or the same optical system. In the case of the same optical system, the microscope 5511 may use different resolutions depending on the capturing target.

The glass slide 800 containing the observation target is placed on a stage located within the field of view of the microscope 5511. The microscope 5511 first acquires an entire image within the field of view using the low-resolution image capturing section, and specifies a region of the observation target from the acquired entire image. Subsequently, the microscope 5511 divides a region where the observation target exists into a plurality of divided regions of a predetermined size, and sequentially captures images of the individual divided regions by the high-resolution image capturing section, thereby acquiring high-resolution images of the individual divided regions. In switching the target divided regions, the stage may be moved, the image capturing optical system may be moved, or both of these may be moved. In addition, each divided region may overlap with an adjacent divided region in order to prevent a failure such as occurrence of image capturing omission regions due to unintended sliding of a glass slide. Furthermore, the entire image may include identification information for associating the entire image with the patient. The identification information may be information such as a character string or a QR code (registered trademark).

The high-resolution image acquired by the microscope 5511 is input to the server 5512. The server 5512 divides each high-resolution image into partial images (hereinafter, referred to as a tiled image) of a smaller size. For example, the server 5512 divides one high-resolution image into a total of 100 tiled images, specifically, 10×10 images in the vertical and horizontal directions. At this time, when the adjacent divided regions overlap each other, the server 5512 may perform stitching processing on the adjacent high-resolution images using a technique such as template matching. In that case, the server 5512 may generate a tiled image by dividing the entire high-resolution image combined by the stitching processing. Note that the generation of the tiled image from the high-resolution image may be performed before the stitching processing.

Furthermore, the server 5512 can further divide the tiled image to generate a tiled image having a smaller size. The generation of such a tiled image may be repeated until completion of generating a tiled image having a size set as a minimum unit.

When having generated the tiled image of the minimum unit in this manner, the server 5512 executes the tile merging processing, which is processing of merging a predetermined number of adjacent tiled images to generate one tiled image, on all the tiled images. This tile merging processing may be repeated until one final tiled image is generated. This processing results in generation of a tiled image group having a pyramid structure in which each hierarchy includes one or more tiled images. In this pyramid structure, a tiled image of a certain layer and a tiled image of a layer different from this layer have the same number of pixels but mutually different resolutions. For example, in a case where a total of four tiled images of 2×2 of a certain layer are merged to generate one tiled image of its upper layer, the resolution of the tiled image of the upper layer is ½ times the resolution of the tiled image of the lower layer used for the merge.

Constructing the tiled image group having such a pyramid structure makes it possible to switch the level of detail of the observation target displayed on the display device depending on the hierarchy of the tiled image to be displayed. For example, it is possible to selectively switch in such a manner that, when the tiled image of the lowermost layer is used, a narrow region of the observation target is displayed in detail, and that the more the tiled image used goes toward the upper layer, the coarser image is displayed for the wider region of the observation target.

The generated tiled image group having the pyramid structure is stored in a storage section (not illustrated) together with identification information (referred to as tile identification information) indicating unique identification of each tiled image, for example. When having received a tiled image acquisition request including tile identification information from another device (for example, the display control device 5513 or the deriving device 5540), the server 5512 transmits a tiled image corresponding to the tile identification information to the another device.

The tiled image being a pathological image may be generated for each image capturing condition such as a focal length and a staining condition. In a case where the tiled image is generated for each image capturing condition, it is also allowable to display, side by side together with a specific pathological image, another pathological image that corresponds to an image capturing condition different from a specific image capturing condition and that belongs to the same region as the specific pathological image. The specific image capturing condition may be designated by the viewer. Furthermore, in a case where a plurality of image capturing conditions has been designated for the viewer, pathological images of the same region corresponding to the individual image capturing conditions may be displayed side by side.

Furthermore, the server 5512 may store the tiled image group having the pyramid structure in a storage device other than the server 5512, for example, a cloud server or the like. Still further, a part or all of the above tiled image generation processing may be executed by a cloud server or the like.

The display control device 5513 extracts a desired tiled image from the tiled image group of the pyramid structure according to the input operation from the user, and outputs the extracted tiled image to the display device 5514. With such processing, the user can obtain a feeling of observing the observation target while changing the observation magnification. That is, the display control device 5513 functions as a virtual microscope. The virtual observation magnification here actually corresponds to the resolution.

Note that any method may be used as a method of capturing a high-resolution image. The divided region may be captured while repeatedly stopping and moving the stage to acquire the high-resolution image, or the divided region may be captured while moving the stage at a predetermined speed to acquire the high-resolution image on a strip. Furthermore, the processing of generating a tiled image from a high-resolution image is not essential, and it is also allowable to generate an image in which the resolution changes stepwise by causing the resolution of the entire high-resolution image combined with the stitching processing to change stepwise. Even in this case, it is possible to perform stepwise presentation of low-resolution images in a wide area range to high-resolution images in a small area to the user.

The medical information system 5530, which is also referred to as an electronic medical record system, stores information related to diagnosis, such as information for identifying a patient, patient disease information, examination information and image information used for diagnosis, a diagnosis result, and prescription medicine. For example, a pathological image obtained by capturing an observation target of a certain patient can be temporarily stored via the server 5512 and thereafter displayed on the display device 5514 by the display control device 5513. The pathologist using the pathology system 5510 performs pathology diagnosis on the basis of the pathological image displayed on the display device 5514. A result of the pathological diagnosis performed by the pathologist is stored in the medical information system 5530.

The deriving device 5540 can analyze the pathological image. The analysis can use a learning model created by machine learning. The deriving device 5540 may derive a classification result of the specific region, an identification result of tissue, and the like as the analysis result. The deriving device 5540 may further derive identification results such as cell information, number, position, and luminance information, scoring information for the identification results, and the like. These pieces of information derived by the deriving device 5540 may be displayed on the display device 5514 of the pathology system 5510 as diagnosis support information.

The deriving device 5540 may be a server system including one or more servers (including a cloud server) or the like. Furthermore, the deriving device 5540 may be incorporated in the display control device 5513 or the server 5512, for example, in the pathology system 5510. That is, various analyses on the pathological image may be executed in the pathology system 5510.

The configuration described above can be applied not only to the medical diagnosis support system but also to all biological microscopes using a digital imaging technology, such as a confocal microscope, a fluorescence microscope, and a video microscope. That is, the configuration described above can be applied to various studies, analyses, investigations, and the like. Here, the observation target may be a biological specimen such as a cultured cell, a fertilized egg, or a sperm, a biological material such as a cell sheet or a three-dimensional cell tissue, or a biological body such as a zebrafish or a mouse.

Furthermore, a moving image may be generated from a still image of the observation target acquired using a microscope using a digital image capturing technology. For example, a moving image may be generated from still images continuously captured for a predetermined period, or an image sequence may be generated from still images captured at predetermined intervals. By generating a moving image from a still image in this manner, it is possible to analyze, with machine learning, dynamic characteristics of the observation target, including movement such as pulsation, elongation, and migration of cancer cells, nerve cells, myocardial tissue, sperm, and the like, as well as a division process of cultured cells and fertilized eggs.

### 8. Supplementary Notes

The preferred embodiments of the present disclosure have been described in detail above with reference to the accompanying drawings. However, the technical scope of the present disclosure is not limited to such examples. It will be apparent to those skilled in the art of the present disclosure that various modifications and alterations can be conceived within the scope of the technical idea described in the claims and naturally fall within the technical scope of the present disclosure.

Furthermore, the effects described in the present specification are merely illustrative or exemplary and are not limited. That is, the technology according to the present disclosure can exhibit other effects that are apparent to those skilled in the art from the description of the present specification in addition to or instead of the above effects.

Note that the present technique can also have the following configurations.
(1) A glass slide conveyance device that conveys a glass slide on which a biological specimen is mounted, the glass slide conveyance device comprising:
   an arm member provided to be movable in a first direction on a plane and having, at a distal end, a first contact member that comes in contact with a first end surface of the glass slide;
   a support plate that includes a second contact member that comes in contact with a second end surface of the glass slide, the second end surface located opposite to the first end surface in the first direction, the supported plate being configured to support the glass slide from below;
   a driver that drives the arm member to be movable in the first direction; and
   a biasing member provided between the driver and the arm member,
   wherein, when the arm member moves to a position where the first contact member and the second contact member simultaneously come in contact with the glass slide, the biasing member biases the arm member in the first direction.
(2) The glass slide conveyance device according to (1),
   wherein the driver includes:
   a rotary disc; and
   a drive member that rotates by transmission of rotation of the rotary disc via the biasing member, and
   the arm member is connected to the drive member and moves in the first direction by the rotation of the drive member.
(3) The glass slide conveyance device according to (1) or (2), wherein the biasing member includes a torsion coil spring.
(4) The glass slide conveyance device according to any one of (1) to (3), wherein the support plate includes two pieces of the second contact members.
(5) The glass slide conveyance device according to any one of (1) to (4),
   wherein the first and second contact members each has a shape of a cylinder, and
   the side surface of the first and second contact members respectively come in contact with the first and second end surfaces of the glass slide.
(6) The glass slide conveyance device according to (5), wherein the side surface is formed of a material subjected to nitriding treatment.
(7) The glass slide conveyance device according to (5), wherein the first and second contact members are formed of a hard ceramic material.
(8) The glass slide conveyance device according to any one of (5) to (7),
   wherein the first and second contact members are provided to be rotatable about a central axis of the cylinder as a rotation axis.
(9) The glass slide conveyance device according to any one of (1) to (8), wherein the support plate is provided to be movable in the first direction.
(10) The glass slide conveyance device according to (2), further comprising a detection mechanism that detects a width of the glass slide in the first direction,
   wherein the detection mechanism includes:
   a light detector including an illuminator and a light receiver provided to face each other; and
   a light shielding member that is connected to the drive member and is capable of blocking light from the illuminator.
(11) The glass slide conveyance device according to (10), wherein the drive member is a disc-shaped member rotatable about a center of the member as a rotation axis.
(12) The glass slide conveyance device according to (11),
   wherein the light shielding member
   is formed as a protrusion protruding outward from a circumference of the drive member, and
   blocks, at a distal end of the protrusion, light from the illuminator.
(13) The glass slide conveyance device according to (12),
   wherein a distance from the distal end of the protrusion to the center of the driving member is twice or more a radius of the drive member.
(14) The glass slide conveyance device according to (10),
   wherein the light shielding member is an L-shaped member having a short rectangular portion and a long rectangular portion connected via a fulcrum,
   an end of the short rectangular portion rotates about the fulcrum as a rotation center in accordance with the rotation of the drive member, and
   an end of the long rectangular portion, which is capable of blocking light from the illuminator, rotates about the fulcrum as a rotation center in accordance with the rotation of the end of the short rectangular portion.
(15) The glass slide conveyance device according to (14), wherein a length of the long rectangular portion is twice or more a length of the short rectangular portion.
(16) The glass slide conveyance device according to any one of (1) to (15), further comprising a guide mechanism that comes in contact with a third end surface of the glass slide and a fourth end surface of the glass slide located opposite to the third end surface in a second direction perpendicular to the first direction and that guides the glass slide to a predetermined position of the support plate.
(17) The glass slide conveyance device according to (16),
   wherein the guide mechanism includes a pair of guide members,
   each of the guide members is provided to be rotatable about a rotation fulcrum provided in a central portion, as a rotation center,
   one end of each of the guide members is moved in the second direction by a guide driver, and
   the other end of each of the guide members is provided with a third contact member that comes in contact with the glass slide.
(18) The glass slide conveyance device according to (17), wherein the guide driver comes in contact with the one end and moves the one end in the second direction by this contact.
(19) The glass slide conveyance device according to (18),
   wherein the guide driver is provided to be movable in the first direction, and
   the one end performs a sliding movement on a side surface of the guide driver, provided obliquely with respect to the first direction, and moves in the second direction by the sliding movement.
(20) A glass slide image capturing system comprising:
   a glass slide storage section that stores a plurality of glass slides on each of which a biological specimen is mounted;
   an image capturing section that captures an image of each of the glass slides; and
   a slide conveyer that conveys each of the glass slides between the glass slide storage portion and the image capturing section,
   wherein the glass slide conveyer includes:
   an arm member provided to be movable in a first direction on a plane and having, at a distal end, a first contact member that comes in contact with a first end surface of the glass slide;
   a support plate that includes a second contact member that comes in contact with a second end surface of the glass slide, the second end surface located opposite to the first end surface in the first direction, the supported plate being configured to support the glass slide from below;
   a driver that drives the arm member to be movable in the first direction; and
   a biasing member provided between the driver and the arm member, and
   when the arm member moves to a position where the first contact member and the second contact member simultaneously come in contact with the glass slide, the biasing member biases the arm member in the first direction.

### REFERENCE SIGNS LIST

10 IMAGE CAPTURING SYSTEM
100 SLIDE STORAGE
102 HOUSING
104 CASSETTE
200 IMAGE CAPTURING BLOCK
202 STAGE
204 STAGE DRIVING MECHANISM
206 MICROSCOPE
300 SLIDE HANDLER
310 WORM WHEEL
312 TORSION COIL SPRING
314 CATCHER ARM DRIVE PLATE
315, 324 CONNECTION MEMBER
316, 316a CATCHER ARM
318, 322, 356 CONTACT MEMBER
320 HANDLER
330 LIGHT SHIELDING MEMBER
330a SHORT RECTANGULAR PORTION
330b LONG RECTANGULAR PORTION
332, 354 FULCRUM
340 DETECTOR
340a ILLUMINATOR
340b LIGHT RECEIVER
350 GUIDE MEMBER
352 END
360 GUIDE DRIVER
362 SIDE SURFACE
800 GLASS SLIDE
802a, 802b, 804a, 804b END SURFACE
806 LABEL PORTION

1. A glass slide conveyance device that conveys a glass slide on which a biological specimen is mounted, the glass slide conveyance device comprising:
an arm member provided to be movable in a first direction on a plane and having, at a distal end, a first contact member that comes in contact with a first end surface of the glass slide;
a support plate that includes a second contact member that comes in contact with a second end surface of the glass slide, the second end surface located opposite to the first end surface in the first direction, the supported plate being configured to support the glass slide from below;
a driver that drives the arm member to be movable in the first direction; and
a biasing member provided between the driver and the arm member,
wherein, when the arm member moves to a position where the first contact member and the second contact member simultaneously come in contact with the glass slide, the biasing member biases the arm member in the first direction.

2. The glass slide conveyance device according to claim 1,
wherein the driver includes:
a rotary disc; and
a drive member that rotates by transmission of rotation of the rotary disc via the biasing member, and
the arm member is connected to the drive member and moves in the first direction by the rotation of the drive member.

3. The glass slide conveyance device according to claim 1, wherein the biasing member includes a torsion coil spring.

4. The glass slide conveyance device according to claim 1, wherein the support plate includes two pieces of the second contact members.

5. The glass slide conveyance device according to claim 1,
wherein the first and second contact members each has a shape of a cylinder, and
the side surface of the first and second contact members respectively come in contact with the first and second end surfaces of the glass slide.

6. The glass slide conveyance device according to claim 5, wherein the side surface is formed of a material subjected to nitriding treatment.

7. The glass slide conveyance device according to claim 5, wherein the first and second contact members are formed of a hard ceramic material.

8. The glass slide conveyance device according to claim 5,
wherein the first and second contact members are provided to be rotatable about a central axis of the cylinder as a rotation axis.

9. The glass slide conveyance device according to claim 1, wherein the support plate is provided to be movable in the first direction.

10. The glass slide conveyance device according to claim 2, further comprising a detection mechanism that detects a width of the glass slide in the first direction,
wherein the detection mechanism includes:
a light detector including an illuminator and a light receiver provided to face each other; and
a light shielding member that is connected to the drive member and is capable of blocking light from the illuminator.

11. The glass slide conveyance device according to claim 10, wherein the drive member is a disc-shaped member rotatable about a center of the member as a rotation axis.

12. The glass slide conveyance device according to claim 11,
wherein the light shielding member
is formed as a protrusion protruding outward from a circumference of the drive member, and
blocks, at a distal end of the protrusion, light from the illuminator.

13. The glass slide conveyance device according to claim 12,
wherein a distance from the distal end of the protrusion to the center of the driving member is twice or more a radius of the drive member.

14. The glass slide conveyance device according to claim 10,
wherein the light shielding member is an L-shaped member having a short rectangular portion and a long rectangular portion connected via a fulcrum,
an end of the short rectangular portion rotates about the fulcrum as a rotation center in accordance with the rotation of the drive member, and
an end of the long rectangular portion, which is capable of blocking light from the illuminator, rotates about the fulcrum as a rotation center in accordance with the rotation of the end of the short rectangular portion.

15. The glass slide conveyance device according to claim 14, wherein a length of the long rectangular portion is twice or more a length of the short rectangular portion.

16. The glass slide conveyance device according to claim 1, further comprising a guide mechanism that comes in contact with a third end surface of the glass slide and a fourth end surface of the glass slide located opposite to the third end surface in a second direction perpendicular to the first direction and that guides the glass slide to a predetermined position of the support plate.

17. The glass slide conveyance device according to claim 16,
wherein the guide mechanism includes a pair of guide members,
each of the guide members is provided to be rotatable about a rotation fulcrum provided in a central portion, as a rotation center,
one end of each of the guide members is moved in the second direction by a guide driver, and
the other end of each of the guide members is provided with a third contact member that comes in contact with the glass slide.

18. The glass slide conveyance device according to claim 17, wherein the guide driver comes in contact with the one end and moves the one end in the second direction by this contact.

19. The glass slide conveyance device according to claim 18,
wherein the guide driver is provided to be movable in the first direction, and
the one end performs a sliding movement on a side surface of the guide driver, provided obliquely with respect to the first direction, and moves in the second direction by the sliding movement.

20. A glass slide image capturing system comprising:
a glass slide storage section that stores a plurality of glass slides on each of which a biological specimen is mounted;
an image capturing section that captures an image of each of the glass slides; and
a slide conveyer that conveys each of the glass slides between the glass slide storage portion and the image capturing section,
wherein the glass slide conveyer includes:
an arm member provided to be movable in a first direction on a plane and having, at a distal end, a first contact member that comes in contact with a first end surface of the glass slide;
a support plate that includes a second contact member that comes in contact with a second end surface of the glass slide, the second end surface located opposite to the first end surface in the first direction, the supported plate being configured to support the glass slide from below;
a driver that drives the arm member to be movable in the first direction; and
a biasing member provided between the driver and the arm member, and
when the arm member moves to a position where the first contact member and the second contact member simultaneously come in contact with the glass slide, the biasing member biases the arm member in the first direction.
